(19) United States
(12) Patent Application Publication
(10) Pub. No.: US 2026/0099888 A1
(43) Pub. Date: Apr. 9, 2026

(54) SYSTEMS AND METHODS FOR REMOTE HOTEL MANAGEMENT

(71) Applicant: EPDPL Coliving Operations Private Limited, Bengaluru (IN)

(72) Inventor: Kahraman Yigit, Bengaluru (IN)

(21) Appl. No.: 19/351,227

(22) Filed: Oct. 6, 2025

Related U.S. Application Data
(60) Provisional application No. 63/704,265, filed on Oct. 7, 2024.

(51) Int. Cl. G06Q 50/12; G06V 20/52; G07C 9/00; H04N 7/15; H04N 7/18

(52) U.S. Cl. CPC G06Q 50/12; G06V 20/53; G07C 9/00309; G07C 9/00904; H04N 7/15; H04N 7/18; G06Q 2220/00; G07C 2009/00412

(57) ABSTRACT

Systems and methods are providing for remotely managing establishments that provide accommodations for guests, such as hotels, motels and the like. A system comprises one or more kiosk(s), each comprising a monitor, a user interface and a controller, such as a computing device or a processor. The controller is configured to receive information from a user via the user interface, verify the information and provide the user with an access code to enter a room within the hotel. The systems and methods enhance operational efficiency, reduce the need for on-site staff, and improve guest experience through contactless interactions and real-time feedback collection. The kiosks may be managed by a remote operator that allows for the management of multiple locations simultaneously, which reduces the need for extensive on-site staff. In addition, this centralized control of multiple properties streamlines management and coordination, and improves resource allocation.

### CROSS-REFERENCE TO RELATED APPLICATIONS

This application claims the benefit of U.S. Provisional Application Ser. No. 63/704,265, filed Oct. 7, 2024, the complete disclosure of which is incorporated herein by reference for all purposes.

### TECHNICAL FIELD

This description generally relates to the field of hospitality management, more particularly to systems and methods for managing hotel operations remotely, and even more particularly to remote hotel management systems that utilize technologies such as video conferencing and/or artificial intelligence (AI) and methods of using such systems.

### BACKGROUND

Hotel management is a type of hospitality administration in the lodging industry that involves overseeing all aspects of the operations of a hotel, motel, lodge, inn or resort. Some of the most common activities of hotel operations include the front office or front desk, reservations, housekeeping, guest experience, revenue, sales and marketing, events and catering, financial management, food and beverage, security, maintenance, human resources and engineering. The hospitality industry, and particularly the hotel industry, was significantly impacted by the COVID-19 pandemic, necessitating innovative solutions to ensure business continuity while adhering to safety protocols.

Traditional hotel management requires substantial human resources, particularly for guest check-ins, customer interaction, and security monitoring, which may not be feasible during pandemics or in properties with low guest volumes. Post-pandemic, the workforce shortage has created challenges to the hotel industry due to its traditional reliance on staffing for daily activities. Adding to this is a change in customer behavior and how they are choosing to manage their hotel experience. The pandemic accelerated a change to the preference of hotel customers to utilize technology to check in and bypass the front desk, signaling a trend in consumer preferences for contactless interactions in their hotel experience. It would therefore be desirable to provide remote management systems and methods to address these challenges.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Systems and methods are providing for remotely managing establishments that provide accommodations for guests, such as hotels, motels, lodges, inns, resorts, rental homes, B&Bs, campgrounds and the like. The systems and methods may include centralized monitoring, operations and management capabilities that enhance operational efficiency, reduce the need for on-site staff, and improve guest experience through contactless interactions and real-time data collection and feedback.

In one aspect, a system for remote hotel management comprises one or more kiosk(s), each comprising a monitor and/or a display and a user interface. The system further comprises a controller, such as a computing device or a configured to receive information from a user via the user interface, the controller being configured to verify the information, and provide the user with an access code to enter a room within the hotel.

In some embodiments, the kiosks represent virtual receptionists for facilitating guest check-in. The kiosks may be installed at strategic locations throughout the hotel or premise, such as a hotel lobby or the like. The kiosks comprise a housing that may be a stand-alone housing or may be coupled to another structure, such as a desk, counter or wall within the hotel. In certain embodiments, the kiosks may be movable and the system may comprise a robotic control system in communication with the kiosks such that the kiosks are movable from a first location to a second location. For example, the kiosks may resemble robots, humans, animals or some other object, and may be configured to move about the premises to facilitate the check-in process.

In some embodiments, the kiosks comprise a video camera that enables live interaction between a remote operator and the user. The video interaction may, for example, comprise intuitive software applications that present a digital image of a virtual receptionist displayed on the monitor. The user interface may comprise any suitable user interface, such as a keyboard, touchscreen, joystick, voice user interface, virtual reality interface, graphical user interface and the like.

In some embodiments, the kiosks may be managed by a remote operator. The remote operator may include one or more personnel that can manage multiple establishments remotely throughout the world. Providing a single remote operation site allows for the management of multiple locations simultaneously, which reduces the need for extensive on-site staff. In addition, this centralized control of multiple properties streamlines management and coordination and improves resource allocation.

The controller may include one or more processors (e.g., microprocessor, microchip, or application-specific integrated circuit), one or more memory devices (e.g., random-access memory and/or read-only memory), an I/O processor, and a communication interface. The processor executes computer program instructions (e.g., an operating system and/or application programs), which can be stored in the memory device and/or the storage system. In certain embodiments, the program instructions or software applications accessible by the kiosks may be aided by an artificial neural network (e.g., machine learning or artificial intelligence).

In some embodiments, the controller comprises a processor and a non-transitory computer-readable storage medium storing program instructions or software applications. The program instructions may cause the processor to provide guest room access instructions on the monitor or through an electronic address of the user, such as email or other social media platforms. In an exemplary embodiment, the program instructions cause the processor to transmit a welcome package to an electronic address of the user. In some embodiments, the program instructions, when executed by the processor, cause the processor to receive payments from the user through the kiosks and process the payments to enable guest check-in.

In some embodiments, the system further comprises digital door locks on various rooms throughout the premises, such as guest rooms within the hotel. The program instructions, when executed by the processor, cause the processor to transmit the access code to the user, e.g., directly through the monitor on the kiosk or to an electronic address of the user, such as email or other social media platforms. This facilitates contactless entry of guest rooms by the guests and a seamless integration with a central control system for remote management of access permissions. The processor may include program instructions, such as an artificial neural network (e.g., machine learning or artificial intelligence) capable of providing encryption and security protocols to enhance guest privacy and safety.

In some embodiments, the program instructions, when executed by the processor, cause the processor to identify the user or guest through the kiosk. In an exemplary embodiment, the program instructions include a facial recognition application configured to record one or more parameters of a face of a user.

In another aspect, a system for remotely managing the operations of one or more hotels is provided. The system comprises a processor in communication with one or more imaging devices, such as video cameras, audio cameras and/or sensors positioned throughout the hotel. The processor includes a non-transitory computer-readable storage medium storing program instructions and/or software applications that cause the processor to interact with the cameras and/or sensors to monitor and control hotel operations. The software applications include one or more algorithms that include sets of instructions to allow the processor to build a model based on the data obtained from the sensors and imaging devices and/or certain data stored within a memory.

In some embodiments, the system further comprises one or more video cameras positioned through the premises and coupled to the processor. The non-transitory computer-readable storage medium stores a second set of program instructions that, when executed by the processor, cause the processor to the second set of program instructions: monitor images of individuals captured by the one or more video cameras and identifies the one or more individuals captured by the one or more video cameras. This allows the system to monitor the premises for unauthorized entries. In an exemplary embodiment, the second set of program instructions cause the processor to develop at least one set of computer-executable rules useable to recognize when one or the individuals present a security risk and to transmit an alert to a remote operator. Providing real-time alerts and notifications ensures prompt action by management and/or security personnel.

In some embodiments, the second set of program instructions cause the processor to develop at least one set of computer-executable rules useable to identify a behavior pattern of the one or more individuals. The system identifies unusual or suspicious behavior patterns, such as loitering or aggressive behavior, to preemptively address potential security threats. In an exemplary embodiment, the processor may include an artificial neural network (e.g., machine learning or artificial intelligence) capable of advanced behavioral analytics to predict and prevent incidents.

In some embodiments, the non-transitory computer-readable storage medium storing program instructions that, when executed by the processor, cause the processor to monitor images of hotel areas, such as public spaces and common areas of the hotel, identifies smoke or flames within these areas and transmits an alert to a remote operator. In an exemplary embodiment, the system comprises one or more sensors, such as temperature sensors and the like, that may be positioned, for example, in the interior of guest rooms to monitor for smoke or flames. The processor may include an artificial neural network (e.g., machine learning or artificial intelligence) capable of multi-sensor analysis to reduce false positives.

In some embodiments, the non-transitory computer-readable storage medium storing program instructions that, when executed by the processor, cause the processor to identify cleaning activities and develops at least one set of computer-executable rules useable to recognize when the cleaning activities fall below a threshold level. The processor ensures that hygiene standards are met by detecting cleaning and mopping activities and alerting management if standards are not met. The processor may include an artificial neural network capable of recognizing specific cleaning patterns and timestamps.

In some embodiments, the non-transitory computer-readable storage medium stores program instructions that, when executed by the processor, cause the processor to develop at least one set of computer-executable rules useable to analyze a density of individuals in one or more areas of the hotel and transmit an alert to a remote operator when the density exceeds a threshold level. The processor may include an artificial neural network capable of analyzing peak hours and crowd density to control crowding situations. In an exemplary embodiment, the system further comprises one or more temperature sensors configured for positioning in the one or more areas of the hotel and coupled to the processor. The second set of program instructions may be configured to generate a heat map of the one or more areas based on temperature detected by the one or more temperature sensors.

In some embodiments, the non-transitory computer-readable storage medium storing program instructions that, when executed by the processor, cause the processor to analyze the demographics of guests and staff in specific areas of the hotel. The processor may include an artificial neural network capable of ensuring appropriate gender segregation and other demographic considerations, and/or provide detailed demographic reports to a remote operator for operational insights or other purposes.

In some embodiments, the non-transitory computer-readable storage medium storing program instructions that, when executed by the processor, cause the processor to use facial recognition captured by the video cameras to record attendance, monitor unauthorized access and/or reduce manual record-keeping discrepancies.

In some embodiments, the non-transitory computer-readable storage medium storing program instructions that, when executed by the processor, cause the processor to monitor energy consumption within one or more areas of the hotel. The processor may include an artificial neural network capable of optimizing resource utilization to reduce operational costs.

In accordance with another aspect, a method for remotely managing a hotel comprises providing one or more kiosks, each kiosk comprising a monitor and a user interface, receiving information from a user via the user interface of one of the kiosks, verifying the information and providing the user with an access code to enter a room within the hotel.

In some embodiments, the method further comprises enabling a digital door lock on a door of the room to be opened with the access code. The access code may be displayed to the user on the monitor or transmitted to an electronic address of the user. In an exemplary embodiment, the method further comprises remotely changing the access code.

In some embodiments, a video image of a remote operator is displayed on the monitor. The video image allows the user to interact with the remote operator. In an exemplary embodiment, the remote operator is a digital image of a virtual receptionist.

In some embodiments, the method further comprises recording one or more parameters of a face of the user. The method may further comprise capturing images of one or more areas of the hotel or premise and identifying guests based on the facial recognition.

In some embodiments, the method further comprises receiving payments from the user and processing the payments on the kiosk. The method may include providing access instructions to the user on the monitor, transmitting a welcome package to an email of the user via the kiosk and/or recognizing returning users and updating loyalty programs.

In certain embodiments, the method comprises remotely controlling movement of the one or more kiosks from a first location to a second location. For example, the one or more kiosks may be configured to move from at least a first position to a second position around the hotel.

In some embodiments, the method comprises capturing images of individuals in one or more areas of the hotel and identifying the individuals captured by the one or more video cameras. In an exemplary embodiment, the method includes identifying one or more parameters of a face of the individuals and comparing these parameters with known parameters or guests of the hotel for security or other purposes. In an exemplary embodiment, the processor develops at least one set of computer-executable rules useable to recognize when one of the individuals present a security risk and transmits an alert to a remote operator.

In some embodiments, the processor develops at least one set of computer-executable rules useable to identify a behavior pattern of the one or more individuals.

In some embodiments, the method comprises monitoring images of hotel areas, detecting smoke or flames within these areas and transmitting an alert to a remote operator, if smoke or flames is detected.

In some embodiments, the method further comprises identifying cleaning activities and developing at least one set of computer-executable rules useable to recognize when the cleaning activities fall below a threshold level.

In some embodiments, the method comprises developing at least one set of computer-executable rules useable to analyze a density of individuals in one or more areas of the hotel and transmitting an alert to a remote operator when the density exceeds a threshold level. In an exemplary embodiment, a heat map is generated of the one or more areas based on temperature detected by one or more temperature sensors.

In accordance with another aspect, a system comprises one or more mobile kiosks, each including a chassis, a monitor, a user interface, and a drive mechanism configured to enable movement of the mobile kiosk within the hotel environment. The system comprises a controller coupled to the one or more mobile kiosks and configured to actuate the drive mechanism to move the one or more mobile kiosks.

The drive mechanism may include one or more ground-engaging members, such as wheels, casters, treads, or legs, and one or more actuators coupled to the ground-engaging members to provide motive force, allowing the kiosk to move from a first location to a second location. The one or more mobile kiosks may further include sensors for detecting surrounding objects and brakes for decelerating or maintaining position, thereby improving safety and operational reliability.

The system further includes a controller, which may comprise a robotic control system with a processor and a non-transitory computer-readable storage medium storing program instructions. When executed by the processor, the instructions cause the controller to actuate the drive mechanism, navigate the one or more mobile kiosks autonomously or semi-autonomously, and coordinate movement between locations within the hotel. The controller may receive information from a user via the kiosk user interface, verify the information, and provide the user with an access code for entry to a hotel room.

In certain embodiments, the system includes digital door locks installed on doors of hotel rooms. Each digital door lock may comprise a lock bolt and an actuator configured to move the bolt between locked and unlocked positions. The digital door lock may further include a lock controller with a processor, a memory, and a wireless transceiver. The wireless transceiver is configured to receive an encrypted access token transmitted by the controller. Program instructions stored in the memory may cause the lock controller to receive, decrypt, and authenticate the access token within a hardware cryptographic module, and upon successful authentication, generate a control signal to actuate the lock bolt to the unlocked position. This configuration allows for secure, contactless access to hotel rooms and seamless integration with a central hotel management system.

The system provides several technical advantages, including autonomous or semi-autonomous operation of mobile kiosks within hotel spaces; enhanced safety through object detection and braking systems; secure generation, transmission, and authentication of access tokens; and improved guest experience by integrating mobile kiosks with digital door locks for contactless room entry. Additionally, the use of hardware cryptographic modules and encrypted access tokens ensures protection against unauthorized access, replay attacks, and tampering, while maintaining efficient and reliable operation of both the mobile kiosks and the digital door locks.

It is to be understood that both the foregoing general description and the following detailed description are exemplary and explanatory only and are not restrictive. Additional features will be set forth in part in the description which follows or may be learned by practice of the description.

### BRIEF DESCRIPTION OF THE DRAWINGS

The accompanying drawings, which are incorporated in and constitute a part of this specification, illustrate several embodiments, and serve to explain the principles herein.

FIG. 1 schematically illustrates a hotel management system;

FIG. 2 is a flowchart of a system and method for capturing images and transmitting date with the hotel management system of FIG. 1;

FIG. 3 is a flow chart illustrating a guest check-in process;

FIG. 4 is a flow chart illustrating a centralized monitoring system of the hotel management system of FIG. 1;

FIG. 5 is a flow chart illustrating a system and method for transmitting data with the hotel management system of FIG. 1;

FIG. 6 is a flow chart of another embodiment of a hotel management system including property management systems and third-party applications; and

FIG. 7 is a flow chart of a process for managing the entire guest visit at a hotel with a remote hotel management system.

### DETAILED DESCRIPTION

This description and the accompanying drawings illustrate exemplary embodiments and should not be taken as limiting, with the claims defining the scope of the description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Systems and methods are providing for remotely managing establishments that provide accommodations for guests, such as hotels, motels, lodges, inns, hotels, B&Bs, campgrounds and the like. The systems and methods may include virtual receptionists, AI-powered video analytics, digital door locks, and centralized monitoring and management capabilities. The systems and methods enhance operational efficiency, reduce the need for on-site staff, and improve guest experience through contactless interactions and real-time feedback collection. It should be understood that, while the systems and methods described herein refer to management of a “hotel”, such systems and methods are not limited in application to hotels only, and can easily be applied to other rental or temporary guest lodging or structures, such as motels, hostels, lodges, inns, resorts, apartments, rental homes, B&Bs, campgrounds and the like.

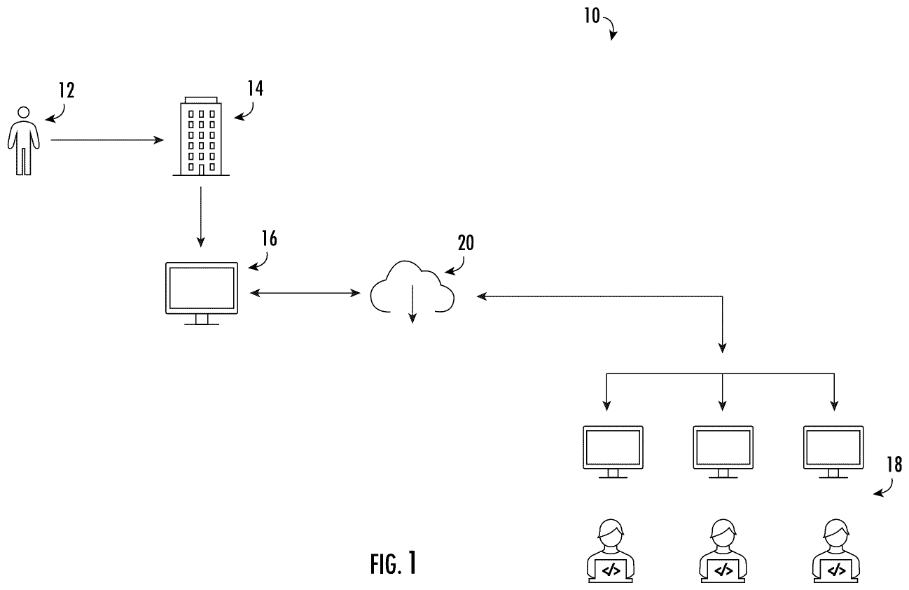

Referring now to FIG. 1, a system 10 is provided for remotely managing establishments 14 that provide accommodations for users 12. As shown, system 10 comprises one or more kiosk(s) 16 that may be positioned in certain strategic areas of the establishment or hotel 14, such as a lobby, entrance, exterior, or other area within or outside of the hotel 14. Kiosks 16 are each remotely coupled to one or more remote operator(s) 18 by any suitable internet connection 20, such as wireless, cellular, cable, satellite, DSL, modem, optical fiber, broadband or broadband over powerlines (BPL), WAN, Bluetooth, direct wired connections or the like.

In certain embodiments, kiosks 16 represent virtual receptionists for guest check-in and each comprise a housing that may be a stand-alone housing or may be coupled to another structure. In an exemplary embodiment, the kiosks 16 comprise a monitor, a user interface and a video camera, such as webcam, HD webcam or the like, that enables live interaction between remote operator(s) 18 and the user 12. The system may comprise a computing device and intuitive software applications that present a digital image of a virtual receptionist displayed on the monitor.

As used herein, the term “kiosk” refers to any service-providing unit configured to facilitate interaction between a user and a system. A kiosk may include, but is not limited to, a housing, enclosure, cabinet, chassis, or other structure supporting one or more user interface elements such as a display, touchscreen, keypad, microphone, speaker, card reader, biometric sensor, or dispensing mechanism. A kiosk 16 may further comprise internal electronics, including one or more processors, memory devices, communication modules, and power sources.

A kiosk 16 may be implemented in a stationary form, such as a freestanding or wall-mounted unit, or in a movable form, such as a mobile or robotic system capable of relocation within an environment. The movable kiosk may incorporate a mobility system and a robotic control system as described herein. In certain embodiments, the kiosk may provide services in a hotel or hospitality setting, including but not limited to guest check-in, concierge information, key card dispensing, payment processing, or delivery of items. In other embodiments, the kiosk may provide retail, healthcare, transportation, or general information services.

Kiosks 16 provide a seamless integration with existing hotel management systems for check-in and payment processing. They may include support from various video conferencing programs, such as DTEN, Zoom, Teams and the like. The user interface may comprise any suitable user interface, such as a keyboard, touchscreen, joystick, voice user interface, virtual reality interface, graphical user interface and the like.

Kiosks 16 may further comprise a computing device and a non-transitory computer-readable storage medium storing program instructions or software applications that perform various functions. The computing device can include one or more processors (e.g., microprocessor, microchip, or application-specific integrated circuit), one or more memory devices (e.g., random-access memory and/or read-only memory), an I/O processor, and a communication interface. The processor executes computer program instructions (e.g., an operating system and/or application programs), which can be stored in the memory device and/or the storage system. The memory devices can include a local memory (e.g., a random-access memory and a cache memory) employed during execution of program instructions. Additionally, the computing device can include at least one communication channel (e.g., a data bus) by which it communicates with the storage system, I/O processor, and the communication interface.

It is noted that the computing device can comprise any general-purpose computing article of manufacture capable of executing computer program instructions installed thereon. However, the computing device is only representative of various possible computing devices that can perform the processes described herein. To this extent, In some embodiments, the functionality provided by the computing device can be any combination of general and/or specific purpose hardware and/or computer program instructions. In each embodiment, the program instructions and hardware can be created using standard programming and engineering techniques.

System 10 may further include one or more imaging devices, one or more sensors in communication with the processor. The software applications include one or more algorithms that include sets of instructions to allow the processor to build a model based on the data obtained from the sensors and imaging devices and/or certain data stored within a memory. Suitable sensors for use with system 10 may include temperature sensors, light sensors, humidity sensors, gas sensors, infrared sensors, proximity sensors, touch sensors, encoders, digital sensors, PCT and microarray based sensors, optical sensors (e.g., bioluminescence and fluorescence), piezoelectric, potentiometric, amperometric, conductometric, nanosensors or the like.

In certain embodiments, the program instructions or software applications accessible by kiosks 16 may be aided by an artificial neural network (e.g., machine learning or artificial intelligence). Machine learning is the scientific study of algorithms and statistical models that computer systems use to perform a specific task without using explicit instructions, relying on patterns and inference instead. Machine learning algorithms build a mathematical model based on sample data, known as “training data”, in order to make predictions or decisions without being explicitly programmed to perform the task. The artificial neural network may use algorithms, heuristics, pattern matching, rules, deep learning and/or cognitive computing to approximate conclusions without direct human input. Because the AI network can identify meaningful relationships in raw data, it can be used to support diagnosing, treating and predicting outcomes in many medical situations. The artificial neural network includes one or more trained machine learning algorithms that process the data received from the imaging devices, user interface and./or the sensors and compares this data with data within the memory.

In certain embodiments, the kiosks 16 may comprise a robotic control system (not shown) in communication with the kiosks such that the kiosks are movable from a first location to a second location. For example, the kiosks may resemble robots, humans, animals or some other object, and may be configured to move about the premises to facilitate the check-in process.

In some embodiments, the kiosks 16 includes a mobility system configured to permit the kiosk to be relocated within a hotel environment. The mobility system may comprise one or more ground-engaging members, such as wheels, casters, tracks, treads, rollers, or legs. The ground-engaging members may be powered, passive, or a combination thereof, and may be arranged to support linear, omni-directional, or holonomic movement. In certain implementations, the mobility system may also encompass non-traditional propulsion systems, such as an air cushion or hovering mechanism, thereby permitting movement without continuous ground contact.

The mobility system may further include a drive mechanism operable to provide motive force to the ground-engaging members. The drive mechanism can comprise one or more motors, actuators, or servomechanisms, which may be coupled to the ground-engaging members either directly or through transmission elements such as gears, belts, chains, or couplings. In embodiments employing wheels, the drive mechanism may include differential drive wheels, caster wheels, or omni-directional wheels (e.g., mecanum wheels). In other embodiments, the drive mechanism may power a set of tracks or treads for improved traction, or actuators coupled to joints of robotic legs for stepping locomotion. The drive mechanism may be powered by an onboard energy source such as a rechargeable battery pack, or by external power supplied through a tether or docking station. A braking subsystem may also be included to maintain the kiosk's position or control deceleration.

Operation of the mobility system may be coordinated by a robotic control system. The robotic control system may include one or more processors executing program instructions stored in a memory, the program instructions being operable to control navigation, localization, user interaction, and task execution. The robotic control system may be in communication with a plurality of sensors, including but not limited to cameras, lidar, ultrasonic range finders, infrared sensors, inertial measurement units, and wheel encoders. These sensors may enable the kiosk to detect obstacles, determine location, and plan navigation paths.

In certain embodiments, the robotic control system provides autonomous navigation, permitting the kiosk to traverse a lobby, corridor, or other hotel space without human intervention. In other embodiments, the robotic control system may permit semi-autonomous operation or teleoperation by a staff member via a wireless interface. The robotic control system may further coordinate guest interaction modules (e.g., a touchscreen display, microphone, speaker, or dispensing mechanism) with locomotion functions, thereby enabling the kiosk to serve as a mobile concierge, check-in station, or delivery robot.

The drive mechanism and robotic control system may incorporate safety features, including collision avoidance algorithms, speed governors, and emergency stop functions. In still further embodiments, the robotic control system may employ machine learning or adaptive algorithms to improve navigation efficiency, obstacle avoidance, or guest interactions over time.

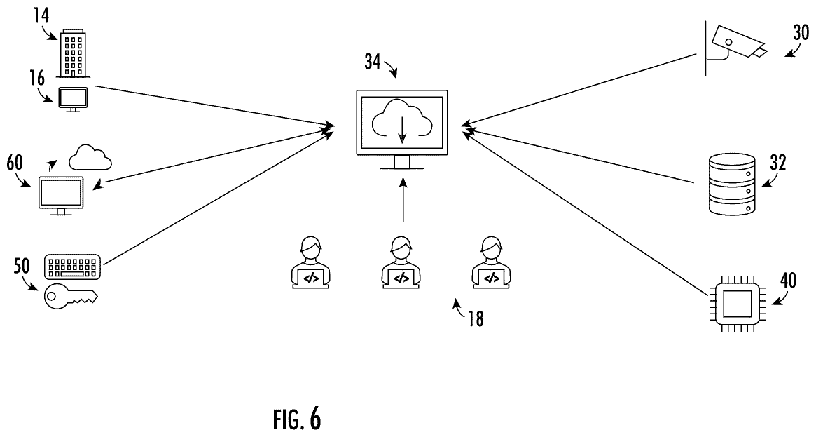

In one embodiment, a system is provided for controlling access to a room in the hotel. The software application or program instructions, when executed by the processor: receive information from a user 12 via the user interface, verify the information, and provide the user 12 with an access code to enter a room within the hotel. System 10 further comprises digital door locks 50 (see FIG. 6) on various rooms throughout the premises, such as guest rooms within the hotel. The program instructions, when executed by the processor, transmit the access code to the user 12, e.g., directly through the monitor on the kiosk 16 or to an electronic address of the user, such as email or other social media platforms. This facilitates contactless entry of guest rooms by the guests and a seamless integration with a central control system for remote management of access permissions.

In certain embodiments, the digital door lock device is mounted to a door and comprises a lock actuator, a secure element, and a wireless transceiver. The lock actuator is configured to actuate a bolt to lock or unlock the door. The secure element is configured to securely store a private cryptographic key and, in some embodiments, may include a trusted platform module (TPM) or hardware security module (HSM) to ensure secure key storage and cryptographic operations. The wireless transceiver is configured to receive access messages from a remote controller or other authorized device.

The system further includes a remote controller comprising a processor and a memory storing program instructions. When executed by the processor, the program instructions cause the processor to generate an ephemeral access token by signing a payload comprising a room identifier and a timestamp using a private key of a trusted provisioning authority. The ephemeral access token may also include a nonce or other unique identifier to prevent replay attacks. Once generated, the remote controller transmits the ephemeral access token to the digital door lock device via the wireless transceiver.

Upon receipt of the ephemeral access token, the digital door lock device is configured to verify and validate the token before actuating the lock. Verification may include checking the cryptographic signature of the ephemeral access token using a public key provisioned in the secure element. Validation may include comparing the timestamp against a locally stored time or allowable time window and confirming that the nonce has not been previously used, thereby preventing expired or replayed tokens from unlocking the door. Only if the verification and validation steps succeed does the lock actuator actuate to unlock the door, thereby ensuring secure and controlled access to the room.

In some embodiments, the digital door lock device may perform offline verification, enabling the lock to operate without continuous network connectivity while maintaining security against unauthorized access. The secure element may also store a list of previously used nonces or maintain counters to prevent replay of access tokens. In addition, the lock actuator may include fail-safe mechanisms, such as returning to a locked state during power failure or providing manual override functionality for emergency situations.

The system provides several technical advantages over conventional access control methods. By utilizing ephemeral access tokens signed by a provisioning authority and verified within a secure element of the door lock, the system prevents replay attacks, mitigates unauthorized access, and enables robust, tamper-resistant operation. The use of secure cryptographic operations at the device level, combined with timestamp and nonce validation, improves the reliability, safety, and security of access control for rooms in environments such as hotels, offices, or residential buildings.

In further embodiments, the remote controller may integrate with a hotel management system or central control system, allowing dynamic generation of access tokens, revocation of previously issued tokens, and tracking of access events. The system may also provide encrypted communication between the remote controller and the digital door lock, further enhancing security and privacy for users. Additional features may include automated logging of entry events, integration with mobile applications, or interoperability with multiple doors and access zones within a facility.

The processor may include program instructions capable of providing encryption and security protocols to enhance guest privacy and safety. The digital door locks 50 may be compatible with various publicly available smart lock brands and technologies for flexible deployment. In certain embodiments, the systems may include software programs and/program instructions on a processor to provide real-time status monitoring and alerting for any malfunctions or unauthorized attempts to access. These software programs may include the ability to change access codes remotely to provide flexible check-in and check-out status.

In some embodiments, the program instructions, when executed by the processor, identify the user or guest through the kiosk 16. In an exemplary embodiment, the program instructions include a facial recognition application configured to record one or more parameters of a face of user 12.

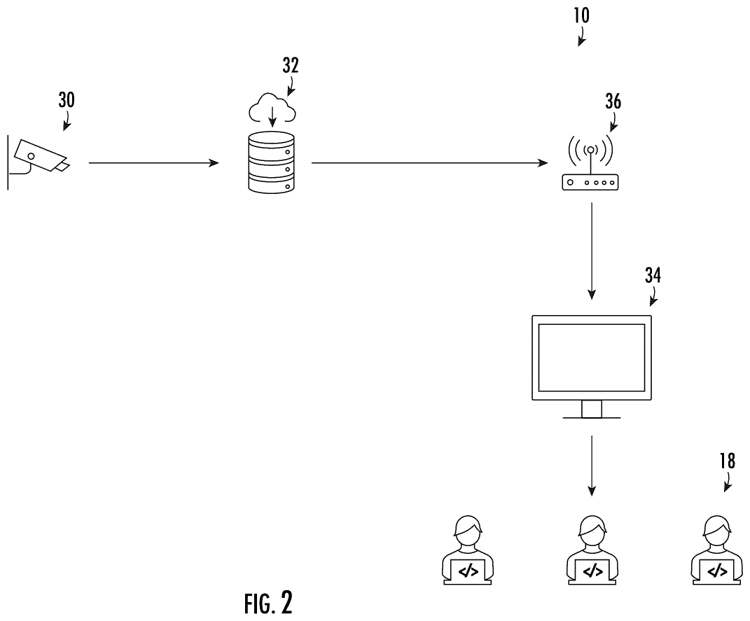

As shown in FIG. 2, system 10 may further comprise one or more video cameras 30, such as general CCTV cameras, dome cameras, bullet cameras, C-mount cameras, PTZ cameras or the like, positioned through the premises and coupled to the processor, for capturing images of users 12 (or other individuals) as they enter the premises and/or interact with kiosks 16. Video cameras 30 may be suitable coupled to a data storage device 32, such as a DVR, flash memory, cloud storage, network-attached storage, hard drive, optical storage or the like, to store image data, which may be displayed on a display unit 34 via a wireless connection 36, such as wireless, cellular, cable, satellite, DSL, modem, optical fiber, broadband or broadband over powerlines (BPL), WAN, Bluetooth, direct wired connections or the like, and accessed by remote operators 18.

The non-transitory computer-readable storage medium storing program stores a second set of program instructions that, when executed by the processor, causes the processor to monitor and identify images of individuals captured by the one or more video cameras. This allows the system to monitor the premises for unauthorized entries. In an exemplary embodiment, the second set of program instructions is configured to develop at least one set of computer-executable rules useable to recognize when one or the individuals present a security risk and to transmit an alert to a remote operator. Providing real-time alerts and notifications ensures prompt action by management and/or security personnel

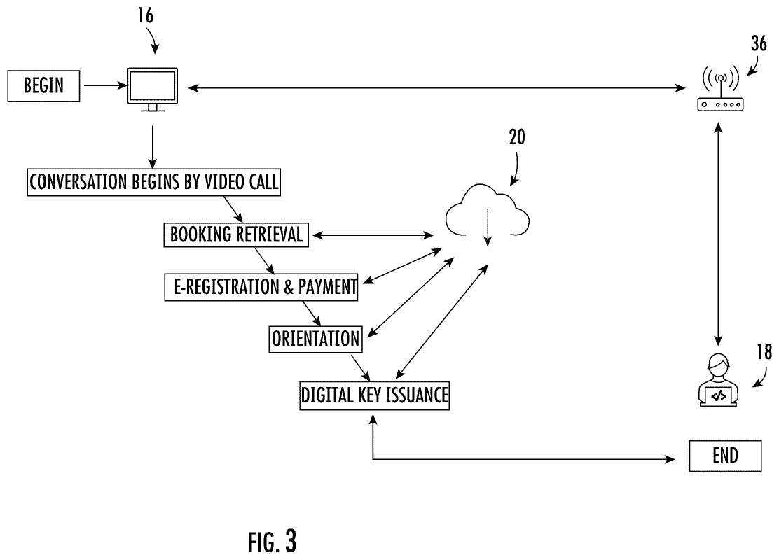

FIG. 3 illustrates one embodiment of a method for remotely managing guest check-in to a hotel room. As shown, the guest or user 12 may approach a kiosk 16 to initiate communication with the remote operators or reception staff 18, who are connected through a suitable internet connection 20, as discussed above. The communication may be verbal, written or through a video call wherein the user interacts directly with the operator 18, or a virtual representation of the operator 18. Upon initiating contact, the virtual receptionist on kiosk 16 verifies guest information, processes payments, and provides access instructions. Digital door lock access codes are then sent to the user 12 for contactless entry. In certain embodiments, the entire check-in process is logged and monitored for quality control and process optimization. In some embodiments, the guests may receive a digital welcome package via email or messaging application, including property information and contact details. In some embodiments, the guest registration may be integrated with loyalty programs to provide personalized offers and rewards to returning guests. Real-time support may be provided through video conferencing with operators 18.

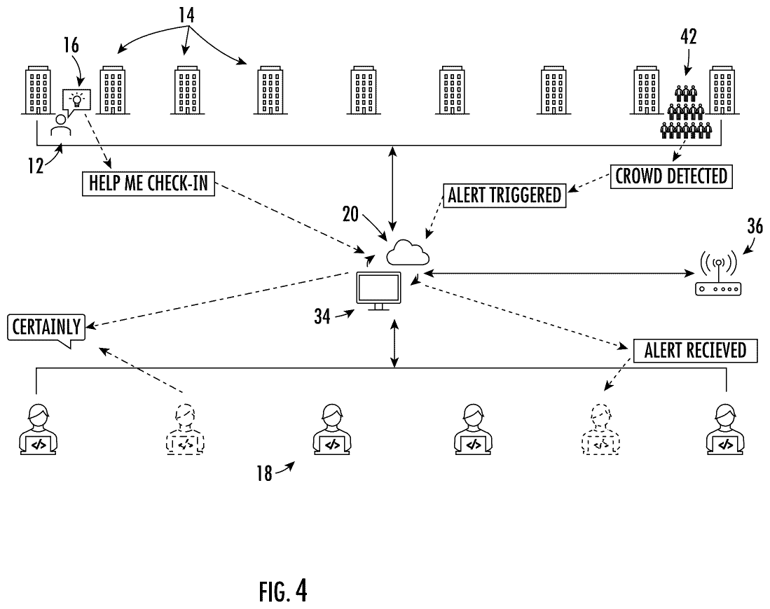

Referring now to FIG. 4, system 10 may have additional functionality. For example, in certain embodiments, the system includes a processor (which may be within kiosk 16, a computer controlled by remote operators 18 or another location within the establishment 14). The processor includes a non-transitory computer-readable storage medium storing program stores a second set of program instructions that, when executed by the processor, develops at least one set of computer-executable rules useable to analyze a density of individuals in one or more areas of the hotel and transmits an alert to a remote operator when the density exceeds a threshold level. The processor may include an artificial neural network capable of analyzing peak hours and the density of a crowd 42 to control crowding situations. In an exemplary embodiment, the system further comprises one or more temperature sensors (not shown) configured for positioning in the one or more areas of the hotel 14 and coupled to the processor. The second set of program instructions may be configured to generate a heat map of the one or more areas based on temperature detected by the one or more temperature sensors.

In some embodiments, the non-transitory computer-readable storage medium stores a second set of program instructions that, when executed by the processor, causes the processor to analyze the demographics of guests and staff in specific areas of the hotel. The processor may include an artificial neural network capable of ensuring appropriate gender segregation and other demographic considerations, and/or provide detailed demographic reports to a remote operator for operational insights or other purposes.

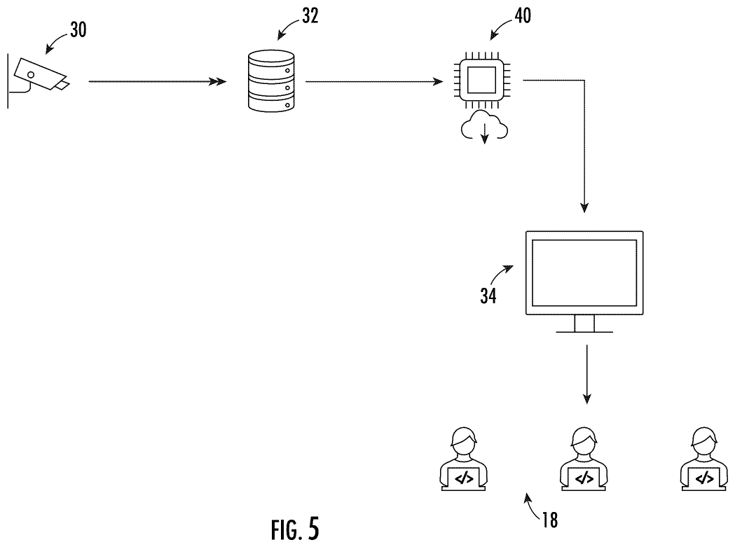

FIG. 5 illustrates another embodiment comprising one or more AI-enabled audio and/or video cameras 30 that are configured for positioning in various locations through the hotel. Each of the cameras 30 may be connected to a display unit 34 which is viewable by remote operators. In this embodiment, system 10 includes a data storage device 32, such as a DVR, flash memory, cloud storage, network-attached storage, hard drive, optical storage or the like, that feeds the data into a cloud computing system 40, such as the Jarvis Gateway (Maverick) or the like. The data is then transmitted to a processor connected to display unit 34.

In some embodiments, the processor may include one or more program instructions configured to develop at least one set of computer-executable rules useable to provide operational monitoring of the hotel, including cleanliness, security and/or crowd management.

A process for remotely monitoring the operations of an establishment, such as a hotel, may include one or more of the following steps: (1) a video analytics program or processor, that incorporates one or more programs instructions, such as artificial intelligence or machine languages, monitors key operational aspects of the hotel, such as cleanliness, security, and crowd management; (2) real-time alerts and notifications are sent to the central control system for any non-compliance or emergencies; (3) continuous monitoring ensures adherence to standard operating procedures (SOPs); (4) regular audits and reviews of video analytics data may be provided to management to identify trends and areas for improvement; (5) the data may be integrated with incident management systems for streamlined reporting and resolution of issues; (6) automated compliance checks may be provided to ensure regulatory adherence and safety standards; (7) predictive analytics may be provided by artificial intelligence or machine language programs for maintenance and operational optimization; and/or (8) historical data analysis may be provided to focus trends and prepare for future operational needs.

In one embodiment, the program instructions are configured to develop at least one set of computer-executable rules useable identify a behavior pattern of one or more individuals within the hotel 14. The system identifies unusual or suspicious behavior patterns, such as loitering or aggressive behavior, to preemptively address potential security threats. In an exemplary embodiment, the processor may include an artificial neural network capable of advanced behavioral analytics to predict and prevent incidents.

In other embodiments, the non-transitory computer-readable storage medium storing program stores a set of program instructions that, when executed by the processor: causes the processor to monitor images of certain areas of the hotel, detects smoke or flames within these areas and transmits an alert to a remote operator, if smoke or flames is detected. In an exemplary embodiment, the system comprises one or more sensors, such as temperature sensors and the like. The processor may include an artificial neural network capable of multi-sensor analysis to reduce false positives.

In some embodiments, the non-transitory computer-readable storage medium stores a set of program instructions that, when executed by the processor: causes the process or identify cleaning activities within areas of the hotels and develop at least one set of computer-executable rules useable to recognize when the cleaning activities fall below a threshold level. The processor ensures that hygiene standards are met by detecting cleaning and mopping activities and alerting management if standards are not met. The processor may include an artificial neural network capable of recognizing specific cleaning patterns and timestamps.

In some embodiments, a non-transitory computer-readable storage medium stores a second set of program instructions that, when executed by the processor, monitors energy consumption within one or more areas of the hotel. The processor may include an artificial neural network capable of optimizing resource utilization to reduce operational costs.

Referring now to FIG. 6, another embodiment of system 10 includes a digital access key system 50 that includes digital keys positioned on various rooms throughout the premises, such as guest rooms within the hotel. As discussed above, the program instructions within the processor transmit an access code to the user 12, e.g., directly through the monitor on the kiosk 16 or through a cloud system 60 to an electronic address of the user, such as email or other social media platforms. This facilitates contactless entry of guest rooms by the guests and a seamless integration with a central control system for remote management of access permissions.

As shown, cloud system 60 may be connected to cloud system 34 which is, in turn, connected to video cameras 30, storage 32 and cloud computing system 40. Cloud system 34 connects all of the devices to remote operators 18, such that the virtual reception team can efficiently perform all of the functions described herein.

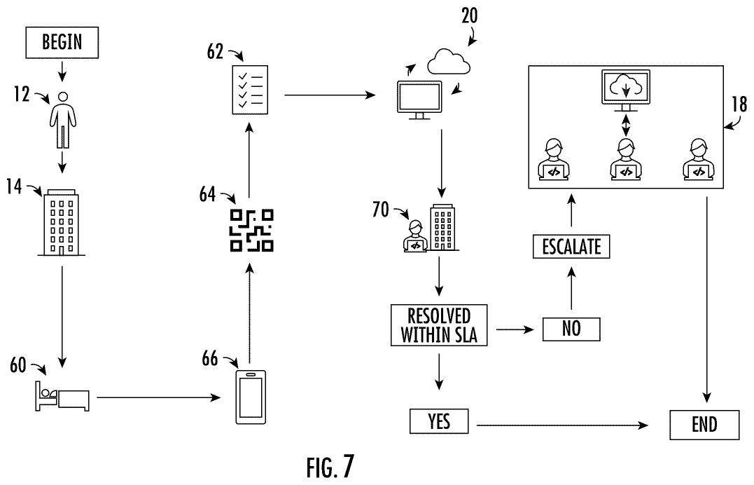

FIG. 7 illustrates a typical lifecycle of the guest 12 request or an incident handling capability of the overall system 10. As shown, when a guest 12 staying in one of the multiple properties 14 being in the comfort of the room 60 has a request or issue 62, the request 62 may be raised through a QR code 64 available in their room 60 using their own Mobile phone device 66. The request is recorded on the cloud system 20 immediately and may be transmitted to a ground team 70 at the hotel or to remote operators 18. Ground team 70 handles the request per the service level agreement (SLA) assigned for the particular task and is handled and closed within the set SLA. In the case of a breach in SLA for the task, the task and the breach are immediately and automatically escalated to virtual reception team 18 through the internet. The virtual reception team are alerted to assist and close the escalation with escalation SLA.

A process for collecting customer feedback from guests may include one or more of the following steps: (1) a notetaker program or processor that incorporates one or more programs instructions, such as artificial intelligence or machine languages transcribes guest conversations and interactions at the kiosks; (2) feedback is analyzed centrally to identify pain points and improve service quality; (3) aggregated data is used to refine and enhance guest experience across all properties; (4) automated surveys and feedback mechanisms may be provided to gather comprehensive guest insights; (5) data-driven decision-making is provided to enhance operational efficiency and guest satisfaction; (6) guest services are personalized based on feedback and interaction history; (7) sentiment analysis is provided to gauge guest satisfaction and address issues proactively; (8) guest feedback and service metrics is tracked on a real-time dashboard; and/or (9) the data is integrated with customer relations management (CRM) systems to maintain detailed guest profiles and history.

The systems and method provided herein provide a number of advantages for managing hotels, including but not limited to, scalability and efficiency, improved guest experience and cost savings. In terms of scalability and efficiency, a single virtual receptionist can manage multiple locations simultaneously, reducing the need for extensive on-site staff. In addition, the systems and methods provide enhanced operational efficiency through real-time monitoring and centralized management, the ability to manage discrepancies such as late checkouts or early check-ins without physical oversight, significant reduction in operational costs by minimizing the need for on-site personnel, the flexibility to scale operations up or down based on demand and occupancy levels, centralized control of multiple properties to streamline management and coordination and improved resource allocation through predictive maintenance and operational optimization and enhanced energy management through integration with smart system.

In terms of improved guest experience, the systems and methods provide at least the following advantages: (1) contactless check-in and entry provide a safe and seamless experience for guests; (2) centralized feedback analysis to facilitate continuously improving service quality; (3) personalization of guest interactions through AI-enabled insights; (4) enhanced security and privacy measures to build guest trust and satisfaction; (5) consistent and high-quality guest experience across all properties; (6) proactive issue resolution and service enhancements based on real-time feedback; (7) real-time interaction capabilities to address guest needs immediately; (8) integration with loyalty programs for personalized guest experiences and rewards; and (9) continuous engagement with guest through automated messaging and updates.

In terms of cost savings, the systems and methods provide at least the following advantages: (1) reduction in human resource requirements and operational costs; (2) automated security and operational monitoring minimize risks and improve overall safety; (3) economies of scale achieved by managing multiple properties from a single location; (4) increased profitability through optimized resource allocation and process efficiency; (5) lower maintenance and operational costs due to predictive analytics and proactive management; (6) streamlined operations reduce overhead and improve financial performance; (7) reduction in liability risks due to enhanced monitoring and real-time alerts; (8) savings from reduced manual record-keeping and compliance management; (9) long-term savings through strategic resource planning and management.

It should be understood that, while the systems and methods described herein refer to the management of a “hotel”, such systems and methods are not limited in application to hotels only, and can easily be applied to other rental or temporary guest lodging or structures. Thus, as used herein, the term “hotel” can also refer to motels, hostels, lodges, inns, resorts, apartments, rental homes, B&Bs, campgrounds and the like, all of which can utilize the systems and methods as described.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in one aspect, a first embodiment is a system for remote hotel management, comprising one or more kiosks, each comprising a monitor and a user interface and a controller in communication with the one or more kiosks, the controller being configured to receive information from a user via the user interface, verify the information and provide an access code to enter a room within a hotel.

A second embodiment is the first embodiment, further comprising a digital door lock on a door of the room, wherein the access code is configured to open the digital door lock.

A third embodiment is any combination of the above embodiments, further comprising a processor and a non-transitory computer-readable storage medium storing program instructions that, when executed by the processor, causes the processor to transmit the access code to an electronic address of the user.

A 4^{th} embodiment is any combination of the above embodiments, wherein the program instructions, when executed by the processor, cause the processor to remotely change the access code.

A 5^{th} embodiment is any combination of the above embodiments, wherein the one or more kiosks further comprise a video camera to enable live video interaction between a remote operator and the user.

A 6^{th} embodiment is any combination of the above embodiments, wherein the video interaction comprises a digital image of a virtual receptionist displayed on the monitor.

A 7^{th} embodiment is any combination of the above embodiments, wherein the user interface comprises a touchscreen.

An 8^{th} embodiment is any combination of the above embodiments, wherein the controller comprises a facial recognition application configured to record one or more parameters of a face of the user.

A 9^{th} embodiment is any combination of the above embodiments, wherein the controller is configured to receive payments from the user and process the payments.

A 10^{th} embodiment is any combination of the above embodiments, wherein the controller is configured to provide access instructions to the user on the monitor.

An 11^{th} embodiment is any combination of the above embodiments, wherein the one or more kiosks each comprise: a drive mechanism that enables movement of the one or more mobile kiosks; and one or more ground-engaging members coupled to the drive mechanism.

A 12^{th} embodiment is any combination of the above embodiments, wherein the one or more kiosks each comprise an actuator coupled to the ground-engaging members and configured to provide motive force to the ground-engaging members to move the one or more kiosks from the first location to the second location.

A 13^{th} embodiment is any combination of the above embodiments, wherein the controller comprises a robotic control system configured to drive the actuator.

A 14^{th} embodiment is any combination of the above embodiments, wherein the robotic control system comprises a processor and a non-transitory computer-readable storage medium storing program instructions that, when executed by the processor, causes the processor to move the one or more kiosks from the first location to the second location.

A 15^{th} embodiment is any combination of the above embodiments, wherein the one or more kiosks comprise a robotic control system that enables the one or more kiosks to move from a first location to a second location.

A 16^{th} embodiment is any combination of the above embodiments, wherein the controller is configured to transmit a welcome package to an email of the user.

A 17^{th} embodiment is any combination of the above embodiments, further comprising an artificial neural network coupled to the controller comprising at least one trained machine learning algorithm.

An 18^{th} embodiment is any combination of the above embodiments, wherein the artificial neural network is configured to recognize returning users and update loyalty programs.

A 19^{th} embodiment is any combination of the above embodiments, further comprising one or more video cameras within the hotel and coupled to the controller.

A 20^{th} embodiment is any combination of the above embodiments, further comprising a processor and a non-transitory computer-readable storage medium storing program instructions that, when executed by the processor, causes the processor to: monitor images of individuals captured by the one or more video cameras; and identifies the one or more individuals captured by the one or more video cameras.

A 21^{st} embodiment is any combination of the above embodiments, wherein the program instructions include a facial recognition application configured to record one or more parameters of a face of the individuals captured by the one or more video cameras.

An 22^{nd} embodiment is any combination of the above embodiments, wherein the program instructions cause the processor to develop at least one set of computer-executable rules useable to recognize when one or the individuals present a security risk and transmits an alert to a remote operator.

A 23^{rd} embodiment is any combination of the above embodiments, wherein the program instructions cause the processor to develop at least one set of computer-executable rules useable to identify a behavior pattern of the one or more individuals.

A 24^{th} embodiment is any combination of the above embodiments, further comprising a processor and a non-transitory computer-readable storage medium storing program instructions that, when executed by the processor, causes the processor to: monitor images of areas of the hotel; detect smoke or flames within the areas; and transmit an alert to a remote operator if smoke or flames is detected.

A 25^{th} embodiment is any combination of the above embodiments, further comprising a processor and a non-transitory computer-readable storage medium storing program instructions that, when executed by the processor, causes the processor to: identify cleaning activities within areas of the hotel; and develop at least one set of computer-executable rules useable to recognize when the cleaning activities fall below a threshold level.

A 26^{th} embodiment is any combination of the above embodiments, further comprising a processor and a non-transitory computer-readable storage medium storing program instructions that, when executed by the processor, causes the processor to: develop at least one set of computer-executable rules useable to analyze a density of individuals in one or more areas of the hotel; and transmit an alert to a remote operator when the density exceeds a threshold level.

A 27^{th} embodiment is any combination of the above embodiments, further comprising one or more temperature sensors configured for positioning in the one or more areas of the hotel and coupled to the computer-readable data storage device, wherein the program instructions cause the processor to generate a heat map of the one or more areas based on temperature detected by the one or more temperature sensors.

A 28^{th} embodiment is any combination of the above embodiments, wherein the door of the room comprises a lock bolt and an actuator configured to move the lock bolt between a locked position and an unlocked position, wherein the digital door lock comprises a lock controller comprising a processor and a memory and a wireless transceiver.

A 29^{th} embodiment is any combination of the above embodiments, wherein the wireless transceiver is configured to receive an encrypted access token, wherein the memory stores instructions that, when executed by the processor, cause the apparatus to: receive, via the wireless transceiver, an encrypted access token; decrypt and authenticate the access token within the hardware cryptographic module; upon successful authentication, generate and send a control signal to the actuator to move the lock bolt to the unlocked position.

In accordance with another aspect, a first embodiment is a method for remotely managing a hotel comprising: providing one or more kiosks, each comprising a monitor and a user interface; receiving information from a user via the user interface of one of the kiosks; verifying the information; and providing the user with an access code to enter a room within a hotel.

A second embodiment is the first embodiment, further comprising enabling a digital door lock on a door of the room to be opened with the access code.

A third embodiment is any combination of the above embodiments, further comprising transmitting the access code to an electronic address of the user.

A 4^{th} embodiment is any combination of the above embodiments, further comprising remotely changing the access code.

A 5^{th} embodiment is any combination of the above embodiments, displaying a video image of a remote operator on the monitor and interacting with the user with the remote operator.

A 6^{th} embodiment is any combination of the above embodiments, wherein the remote operator is a digital image of a virtual receptionist.

A 7^{th} embodiment is any combination of the above embodiments, further comprising recording one or more parameters of a face of the user.

An 8^{th} embodiment is any combination of the above embodiments, further comprising receiving payments from the user and processing the payments on the kiosk.

A 9^{th} embodiment is any combination of the above embodiments, further comprising providing access instructions to the user on the monitor.

A 10^{th} embodiment is any combination of the above embodiments, further comprising remotely controlling movement of the one or more kiosks from a first location to a second location.

An 11^{th} embodiment is any combination of the above embodiments, further comprising transmitting a welcome package to an email of the user via the kiosk.

A 12^{th} embodiment is any combination of the above embodiments, further comprising recognizing returning users and updating loyalty programs.

A 13^{th} embodiment is any combination of the above embodiments, further comprising capturing images of individuals in one or more areas of the hotel and identifying the individuals captured by the one or more video cameras.

A 14^{th} embodiment is any combination of the above embodiments, further comprising identifying one or more parameters of a face of the individuals.

A 15^{th} embodiment is any combination of the above embodiments, further comprising developing at least one set of computer-executable rules useable to recognize when one of the individuals present a security risk and transmits an alert to a remote operator.

A 16^{th} embodiment is any combination of the above embodiments, further comprising developing at least one set of computer-executable rules useable to identify a behavior pattern of the one or more individuals.

A 17^{th} embodiment is any combination of the above embodiments, further comprising: monitoring images of areas of the hotel; detecting smoke or flames within the areas; and transmitting an alert to a remote operator if smoke or flames is detected.

An 18^{th} embodiment is any combination of the above embodiments, further comprising: identifying cleaning activities areas of the hotel; and developing at least one set of computer-executable rules useable to recognize when the cleaning activities fall below a threshold level.

A 19^{th} embodiment is any combination of the above embodiments, further comprising developing at least one set of computer-executable rules useable to analyze a density of individuals in one or more areas of the hotel; and transmitting an alert to a remote operator when the density exceeds a threshold level.

A 20^{th} embodiment is any combination of the above embodiments, further comprising generating a heat map of the one or more areas based on temperature detected by one or more temperature sensors.

In accordance with another aspect, a first embodiment is a system for remote hotel management comprising one or more mobile kiosks, each comprising a chassis, a monitor, a user interface and a drive mechanism that enables movement of the mobile one or more kiosks; and a controller coupled to the one or more mobile kiosks and configured to actuate the drive mechanism to move the one or more mobile kiosks.

A second embodiment is the first embodiment, wherein the one or more mobile kiosks each comprise one or more ground-engaging members coupled to the drive mechanism.

A third embodiment is any combination of the above embodiments, wherein the one or more mobile kiosks each comprise an actuator coupled to the ground-engaging members and configured to provide motive force to the ground-engaging members to move the one or more mobile kiosks from the first location to the second location.

A 4^{th} embodiment is any combination of the above embodiments, further comprising one or more sensors coupled to the chassis for detecting objects surrounding the one or more mobile kiosks.

A 5^{th} embodiment is any combination of the above embodiments, further comprising one or more brakes coupled to the ground-engaging members for decelerating or maintaining a position of the one or more mobile kiosks.

A 6^{th} embodiment is any combination of the above embodiments, wherein the controller comprises a robotic control system configured to drive the actuator.

A 7^{th} embodiment is any combination of the above embodiments, wherein the robotic control system comprises a processor and a non-transitory computer-readable storage medium storing program instructions that, when executed by the processor, causes the processor to move the one or more mobile kiosks from a first location to a second location.

An 8^{th} embodiment is any combination of the above embodiments, wherein the controller is configured to receive information from a user via the user interface, verify the information and provide an access code to enter a room within a hotel.

A 9^{th} embodiment is any combination of the above embodiments, further comprising a digital door lock on a door of the room, wherein the access code is configured to open the digital door lock.

A 10^{th} embodiment is any combination of the above embodiments, further comprising a processor and a non-transitory computer-readable storage medium storing program instructions that, when executed by the processor, causes the processor to transmit the access code to an electronic address of the user.

An 11^{th} embodiment is any combination of the above embodiments, wherein the program instructions, when executed by the processor, causes the processor to remotely change the access code.

A 12^{th} embodiment is any combination of the above embodiments, wherein the one or more mobile kiosks further comprise a video camera to enable live video interaction between a remote operator and the user.

A 13^{th} embodiment is any combination of the above embodiments, wherein the controller comprises a facial recognition application configured to record one or more parameters of a face of the user.

A 14^{th} embodiment is any combination of the above embodiments, wherein the controller is configured to receive payments from the user and process the payments.

A 15^{th} embodiment is any combination of the above embodiments, wherein the controller is configured to provide access instructions to the user on the monitor.

What is claimed is:

1. A system for remote hotel management, comprising:
one or more kiosks, each kiosk comprising a chassis, a monitor and a user interface; and
a controller in communication with the one or more kiosks, the controller being configured to receive information from a user via the user interface, verify the information and provide an access code to enter a room within a hotel.

2. The system of claim 1, further comprising a digital door lock on a door of the room, wherein the access code is configured to open the digital door lock.

3. The system of claim 2, wherein the digital door lock comprises a lock bolt and an actuator configured to move the lock bolt between a locked position and an unlocked position, wherein the digital door lock comprises a lock controller comprising a processor and a memory and a wireless transceiver.

4. The system of claim 3, wherein the wireless transceiver is configured to receive an encrypted access token, wherein the memory stores instructions that, when executed by the processor, cause the digital door lock to:
receive, via the wireless transceiver, an encrypted access token;
decrypt and authenticate the access token within a hardware cryptographic module; and
generate and send a control signal to the actuator to move the lock bolt to the unlocked position.

5. The system of claim 2, further comprising a processor and a non-transitory computer-readable storage medium storing program instructions that, when executed by the processor, causes the processor to transmit the access code to an electronic address of the user.

6. The system of claim 5, wherein the program instructions, when executed by the processor, cause the processor to remotely change the access code.

7. The system of claim 1, wherein the one or more kiosks further comprise a video camera to enable live video interaction between a remote operator and the user.

8. The system of claim 1, wherein the one or more kiosks each comprise:
a drive mechanism that enables movement of the one or more kiosks; and
one or more ground-engaging members coupled to the drive mechanism.

9. The system of claim 8, wherein the one or more kiosks each comprise an actuator coupled to the ground-engaging members and configured to provide motive force to the ground-engaging members to move the one or more kiosks from a first location to a second location.

10. The system of claim 9, wherein the controller comprises a robotic control system configured to drive the actuator.

11. The system of claim 10, wherein the robotic control system comprises a processor and a non-transitory computer-readable storage medium storing program instructions that, when executed by the processor, causes the processor to move the one or more kiosks from the first location to the second location.

12. The system of claim 1, further comprising:
one or more video cameras within the hotel and coupled to the controller; and
a processor and a non-transitory computer-readable storage medium storing program instructions that, when executed by the processor, causes the processor to:
monitor images of individuals captured by the one or more video cameras; and
identify the one or more individuals captured by the one or more video cameras.

13. The system of claim 1, further comprising a processor and a non-transitory computer-readable storage medium storing program instructions that, when executed by the processor, causes the processor to:
develop at least one set of computer-executable rules useable to analyze a density of individuals in one or more areas of the hotel; and
transmit an alert to a remote operator when the density exceeds a threshold level.

14. The system of claim 13, further comprising one or more temperature sensors configured for positioning in the one or more areas of the hotel and coupled to the non-transitory computer-readable storage medium; and
wherein the program instructions cause the processor to generate a heat map of the one or more areas based on temperature detected by the one or more temperature sensors.

15. A system for remote hotel management, comprising:
one or more mobile kiosks, each kiosk comprising a chassis, a monitor, a user interface and a drive mechanism that enables movement of the one or more mobile kiosks; and
a controller coupled to the one or more mobile kiosks and configured to actuate the drive mechanism to move the one or more mobile kiosks.

16. The system of claim 15, wherein the one or more mobile kiosks each comprise one or more ground-engaging members coupled to the drive mechanism.

17. The system of claim 16, wherein the one or more mobile kiosks each comprise an actuator coupled to the ground-engaging members and configured to provide motive force to the ground-engaging members to move the one or more mobile kiosks from a first location to a second location.

18. The system of claim 17, further comprising:
one or more sensors coupled to the chassis for detecting objects surrounding the one or more mobile kiosks; and
one or more brakes coupled to the ground-engaging members for decelerating or maintaining a position of the one or more kiosks.

19. The system of claim 18, wherein the controller comprises a robotic control system configured to drive the actuator, wherein the robotic control system comprises a processor and a non-transitory computer-readable storage medium storing program instructions that, when executed by the processor, causes the processor to move the one or more kiosks from the first location to the second location.

20. The system of claim 15, wherein the controller is configured to receive information from a user via the user interface, verify the information and provide an access code to enter a room within a hotel, the system further comprising a digital door lock on a door of the room, wherein the access code is configured to open the digital door lock.
